(19) United States
(12) Patent Application Publication
(10) Pub. No.: US 2025/0147504 A1
(43) Pub. Date: May 8, 2025

(54) BSR PRE-VALIDATION SYSTEM AND METHOD WITH DOOR TRIM CONTACT POINT ANALYSIS

(71) Applicant: Seoyon E-Hwa Co., Ltd., Anyang (KR)

(72) Inventor: Youngbin CHO, Anyang (KR)

(21) Appl. No.: 18/931,112

(22) Filed: Oct. 30, 2024

(30) Foreign Application Priority Data
Nov. 6, 2023 (KR) 10-2023-0152099

(51) Int. Cl. G05B 23/02

(52) U.S. Cl. CPC G05B 23/0294; G05B 23/0216; G05B 23/0235; G05B 2223/02

(57) ABSTRACT

Provided is a BSR pre-validation system and method with door trim contact point analysis, which includes: an information collection unit obtaining door trim design data, a material database, and BSR improvement history information; a material analysis unit extracting material information of contact surface parts based on the door trim design data and the material database, and determining friction noise risk between matching parts; a pre-validation unit determining contact surfaces with a squeak risk index or rattle risk index higher than or equal to a preset threshold value as an expected risk group; and an improvement measure derivation unit deriving an improvement measure for the expected risk group based on the BSR improvement history information, and at a drawing stage, the improvement measure is derived through BSR pre-validation, and BSR pre-validation and a single-item validation result are compared to confirm a validity of the BSR pre-validation.

### CROSS-REFERENCE TO RELATED APPLICATIONS

This application claims the priority of Korean Patent Application No. 10-2023-0152099 filed on Nov. 6, 2023, in the Korean Intellectual Property Office, the disclosure of which is incorporated herein by reference.

### BACKGROUND

### Field

The present disclosure relates to a BSR pre-validation system and method with door trim contact point analysis which can pre-validate and improve a BSR problem with data analysis at a drawing stage to fundamentally improve BSR noise, which is a chronic problem of automobile interior parts, and to prepare for an increasing trend of a proto less project.

### Description of the Related Art

As the automobile industry evolves, a demand for emotional quality that satisfies consumers' emotions as well as vehicle performance and quality is also increasing. The emotional quality plays a key role in increasing a value and market competitiveness of a vehicle. In particular, noise generated from the vehicle is one of the important criteria for judging the emotional quality. Friction noise, called buzz, squeak, rattle (BSR), appears at the assembly joints or fixed portions of parts, or where friction occurs, and a BSR level is measured to validate the quality of the vehicle after a manufacturing process is completed.

Automobile manufacturers are investing a lot of testing costs and time to meet required specification standards during a development stage to reduce a BSR noise problem, but there is a trend in which field claims related to noise generated inside the vehicle are increasing every year.

### SUMMARY

For the above reasons, one aspect of the present disclosure is to provide a BSR pre-validation system and method with door trim contact point analysis, which can extract a high risk group of expected risks with a high risk of BSR generation in advance through BSR pre-validation at a drawing stage, derive improvement measures, and confirm the validity of BSR pre-validation by comparing results of BSR pre-validation and single-item validation.

A BSR pre-validation system with door trim contact point analysis according to one aspect of the present disclosure may include: an information collection unit obtaining door trim design data, a material database, and buzz, squeak, and rattle (BSR) improvement history information; a material analysis unit extracting material information of parts forming a contact surface based on the door trim design data and the material database, and determining a risk of friction noise between matching parts for each contact surface based on the material database; a pre-validation unit determining a contact surface having a squeak risk index or rattle risk index higher than or equal to a preset threshold value as an expected risk group based on the material information, the risk of friction noise between matching parts, and a contact point analysis (CPA) matrix for each contact surface; and an improvement measure derivation unit deriving an improvement measure for the expected risk group based on the BSR improvement history information.

The material analysis unit may determine the risk of friction noise between matching parts by considering at least one of temperature, humidity, material, load, and speed.

The pre-validation unit may determine the squeak risk index based on a design data gap between matching parts, a friction occurrence possibility, and the risk of friction noise between matching parts for each contact surface.

The pre-validation unit may determine the rattle risk index based on the design data gap between matching parts, a fastening condition, a contact occurrence possibility, and a contact surface for each contact surface.

The BSR pre-validation system may further include a validity confirmation unit confirming a validity of the BSR pre-validation based on a single-item validation result for a door trim prototype produced based on the door trim design data, and the expected risk group.

The validity of the BSR pre-validation may be a ratio of the number of noise cases confirmed at the same site as the expected risk group to the number of noise cases confirmed in the single-item validation result.

The number of noise cases which are not caused due to a design structure may be excluded from the number of noise cases confirmed in the single-item validation result.

A BSR pre-validation method with door trim contact point analysis according to another aspect of the present disclosure may include: a step of obtaining door trim design data; a step of obtaining a material database and buzz, squeak, and rattle (BSR) improvement history information; a material information extracting step of extracting material information of parts forming a contact surface based on the door trim design data and the material database; a material analyzing step of determining the risk of friction noise between matching parts for each contact surface based on the material database; a BSR pre-validating step of determining contact surfaces having a squeak risk index or rattle risk index higher than or equal to a preset threshold value based on the material information, the risk of friction noise between matching parts, and a contact point analysis (CPA) matrix for each contact surface as an expected risk group; and an improvement measure deriving step of deriving an improvement measure for the expected risk group based on the BSR improvement history information.

In the material analyzing step, the risk of friction noise between matching parts may be determined by considering at least one of temperature, humidity, material, load, and speed.

In the BSR pre-validating step, the squeak risk index may be determined based on a design data gap between matching parts, a friction occurrence possibility, and the risk of friction noise between matching parts for each contact surface.

In the BSR pre-validating step, the rattle risk index may be determined based on the design data gap between matching parts, a fastening condition, a contact occurrence possibility, and a contact surface for each contact surface.

The BSR pre-validation method may further include a validity confirming step of confirming a validity of the BSR pre-validation based on a single-item validation result for a door trim prototype produced based on the door trim design data, and the expected risk group.

The validity of the BSR pre-validation may be a ratio of the number of noise cases confirmed at the same site as the expected risk group to the number of noise cases confirmed in the single-item validation result.

The number of noise cases which are not caused due to a design structure may be excluded from the number of noise cases confirmed in the single-item validation result.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram schematically illustrating a configuration of a BSR pre-validation system according to an exemplary embodiment;

FIG. 2 is a diagram exemplarily illustrating that material information of parts forming a contact surface which is a BSR pre-validation target is extracted from a material database according to an exemplary embodiment;

FIG. 3 is a diagram exemplarily illustrating a CPA matrix according to an exemplary embodiment;

FIG. 4 is a diagram exemplarily illustrating a risk of friction noise between matching parts for each contact surface;

FIG. 5 is a diagram illustrating a CPA pre-validation validity confirmed in a CPA pre-validation validity calculation formula and an actual test process according to an exemplary embodiment; and

FIG. 6 is a flowchart illustrating a BSR pre-validation method according to an exemplary embodiment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals refer to like elements throughout the specification. This specification does not describe all elements of the exemplary embodiments, and general content or content overlapping between the exemplary embodiments in the technical field to which the present disclosure pertains is omitted. The term ‘unit, module, member, block’ used in the specification may be implemented as software or hardware, and according to exemplary embodiments, a plurality of ‘units, modules, members, blocks’ may be implemented as one component or it is also possible that one ‘unit, module, member, block’ includes a plurality of components.

Throughout the specification, when a part is said to be “connected” with another part, this includes not only the case of direct connection, but also the case of indirect connection, connection includes connection through a and the: wireless communication network.

In addition, unless explicitly described to the contrary, the word “comprise”, and variations such as “comprises” or “comprising”, will be understood to imply the inclusion of stated elements but not the exclusion of any other elements.

Throughout this specification, it will be understood that when a member is referred to as being “on” another member, it can be directly on the other member or intervening members may also be present.

The terms “first,” “second,”, and the like are used to distinguish one component from other components, but the component is not limited by the terms.

A singular form may include a plural form unless there is a clear exception in the context.

In each step, reference numerals are used for convenience of description, the reference numerals are not used to describe the order of the steps and unless a specific order is clearly stated in the context, each step may occur differently from the order specified above.

Hereinafter, an operation principle and exemplary embodiments of the present disclosure will be described with reference to the accompanying drawings.

In an exemplary embodiment of the present disclosure, buzz, squeak, and rattle (BSR) pre-validation refers to pre-validation for squeak noise and rattle noise excluding buzz.

The rattle noise is noise that occurs when a collision phenomenon occurs between parts due to external vibration or force, and impact energy is released into the air. When one of the matching parts moves due to an external physical force such as physical contact, or due to road vibration or engine vibration, if a movement distance is greater than a separation distance, a collision occurs. The collision often occurs in a series of irregular patterns. If the surface hardness of the matching parts is sufficiently large and an elastic modulus is small, the impact energy generated on the part surface is released to the outside air in large amounts, resulting in an audible sound. The rattle noise is a phenomenon that mainly occurs in vehicle interior parts, and is often caused by tolerances for absorbing assembly dispersion between parts. If the tolerance is set excessively, the parts will move microscopically by the tolerance even when fastened, which will cause impact with adjacent parts under driving conditions, resulting in noise.

The squeak noise is noise that is mainly generated by a stick-slip mechanism, and stick-slip noise is generated in parts that are already in contact or that come into contact due to external force. This is a noise phenomenon that occurs when two parts are repeatedly joined and separated when horizontal displacement occurs on the surface after the two parts come into contact. If one of the adjacent parts is displaced by an external force without a separation distance between the matching parts, a relative displacement occurs between the matching parts. Alternatively, even when a certain separation distance is secured, if the external force is sufficiently large, a relative displacement occurs where the matching parts come into contact. In the case of the stick-slip noise, noise is not generated simply due to the relative displacement between parts, but rather, whether the noise is generated depends on a stick-slip tendency between the matching parts. If the surfaces of the two parts have a strong tendency to slip, no noise is generated even if the relative displacement between the matching parts is large, but if the tendency to stick is strong, stick-slip occurs due to the property of continuously trying to maintain a sticking force while the relative displacement between the matching parts occurs, and the greater the amount of bonding energy released, the more audible the noise is generated. The stick-slip occurrence tendency shows different characteristics depending on an external temperature and relative humidity, and tends to cause audible noise only under certain temperature and relative humidity conditions. When a stick force between objects increases due to the material properties of the surfaces of adjacent materials, or the frictional force increases due to a micro-toothing phenomenon between the surface structures, noise may be generated through repeated stick and slip between the two surfaces.

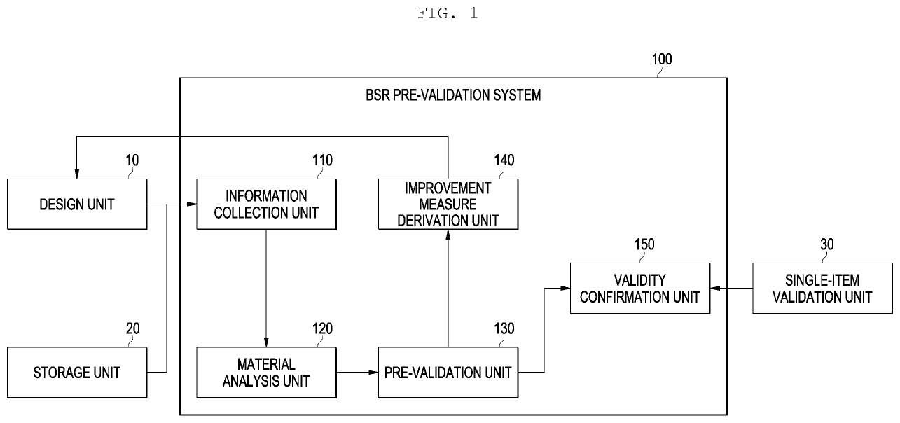

FIG. 1 is a diagram schematically illustrating a configuration of a BSR pre-validation system 100 according to an exemplary embodiment.

The BSR pre-validation system 100 may obtain door trim design data, a material database, and buzz, squeak, and rattle (BSR) improvement history information, extract material information of parts forming a contact surface based on the door trim design data and the material database, determine the risk of friction noise between matching parts for each contact surface based on the material database, determine contact surfaces having a squeak risk index or rattle risk index higher than or equal to a preset threshold based on the material information, the risk of friction noise between matching parts, and a contact point analysis (CPA) matrix for each contact surface as an expected risk group, derive improvement measures for the expected risk group based on the BSR improvement history information, and confirm the validity of the BSR pre-validation based on a single-item validation result for a door trim prototype produced based on the door trim design data, and the expected risk group.

As illustrated in FIG. 1, the BSR pre-validation system 100 may include an information collection unit 110, a material analysis unit 120, a pre-validation unit 130, an improvement measure derivation unit 140, and a validity confirmation unit 150.

The information collection unit 110 may obtain the door trim design data, the material database, and the BSR improvement history information.

The information collection unit 110 may obtain the door trim design data from the design unit 10, and obtain the material database, and the BSR improvement history information from the storage unit 20.

The material analysis unit 120 may extract the material information of the parts forming the contact surface based on the door trim design data and the material database acquired by the information collection unit 110. In addition, the material analysis unit 120 may perform material analysis between matching parts based on the material database. More specifically, the material analysis unit 120 may determine the risk of the friction noise between matching parts for each contact surface based on the material database.

More specifically, the material analysis unit 120 may determine the risk of the friction noise between the matching parts for each contact surface based on a squeak noise test result value between respective matching parts stored in the material database.

The material database stores various information about a part, such as detailed information about material composition, mechanical properties, tolerances, surface treatment, etc. Further, the material database stores a result value of testing the squeak noise between respective matching parts under various conditions such as temperature and humidity in advance using stick-slip test equipment.

The material analysis unit 120 may determine the risk of friction noise between matching parts by considering at least one of temperature, humidity, material, load, and speed.

The pre-validation unit 130 determines a contact surface having a squeak risk index or rattle risk index higher than or equal to a preset threshold as an expected risk group based on the material information, the risk of friction noise between matching parts, and the contact point analysis (CPA) matrix for each contact surface.

Here, the CPA matrix is a kind of matrix for performing CPA, and includes parameter items affecting the squeak risk index and/or rattle risk index between matching parts of each contact surface, a score system, and a separate formula for converting the scores of each parameter item into the squeak risk index and rattle risk index.

The parameter items may include a design data gap, a

fastening condition, a friction occurrence possibility, a contact occurrence possibility, a contact surface, and a risk of friction noise between matching parts. Among these, the risk of friction noise between matching parts is determined through material analysis by the material analysis unit 120 and provided to the CPA matrix.

The pre-validation unit 130 may determine the squeak risk index based on the design data gap between matching parts, the friction occurrence possibility, and the risk of friction noise between matching parts for each contact surface. The pre-validation unit 130 may determine the rattle risk index based on the design data gap between matching parts, the fastening condition, the contact occurrence possibility, and the contact surface for each contact surface.

Among the parameter items, the design data gap is a parameter item commonly applied to the squeak risk index and the rattle risk index. The friction occurrence possibility and the risk of friction noise between matching parts are parameter items applied only to the squeak risk index, and the fastening condition, the contact occurrence possibility, and the contact surface are parameter items applied only to the rattle risk index. This is because, as mentioned above, causes of squeak noise and rattle noise are not the same.

As described above, the pre-validation unit 130 determines the squeak risk index and rattle risk index between matching parts using the CPA matrix. Next, the pre-validation unit 130 determines whether each of the squeak risk index or the rattle risk index is greater than or equal to a preset threshold, and if at least any one of the squeak risk index and the rattle risk index is greater than or equal to the preset threshold, the contact surface formed by the corresponding matching parts is determined as an expected risk group.

The improvement measure derivation unit 140 may derive an improvement measure for the expected risk group based on the BSR improvement history information. The BSR improvement history information may include information about past BSR problems and improvement history.

The validity confirmation unit 150 may confirm the validity of the BSR pre-validation based on the single-item validation result for the door trim prototype produced based on the door trim design data, and the expected risk group.

It should be noted that the door trim prototype produced based on the door trim design data here is door trim design data prior to the BSR pre-validation, without applying the improvement measure derived by the improvement measure derivation unit 140. In other words, even if the BSR pre-validation system 100 determines the expected risk group and derives the improvement measure based on the door trim design data, a door trim prototype actually produced is based on original door trim design data, not the improvement measure.

The validity confirmation unit 150 may confirm the validity based on whether the expected risk group and an actual BSR generation site shown as the single-item validation result by the single-item validation unit 30 are identical. More specifically, the validity of the BSR pre-validation may be a ratio of the number of noise cases confirmed at the same site as the expected risk group to the number of noise cases confirmed in the single-item validation result. Further, the number of noise cases which are not caused due to the design structure may be excluded from the number of noise cases confirmed in the single-item validation result.

The validity of the BSR pre-validation confirmed by the validity confirmation unit 150 may be used as feedback data for determining the accuracy of the BSR pre-validation system 100 and improving the accuracy.

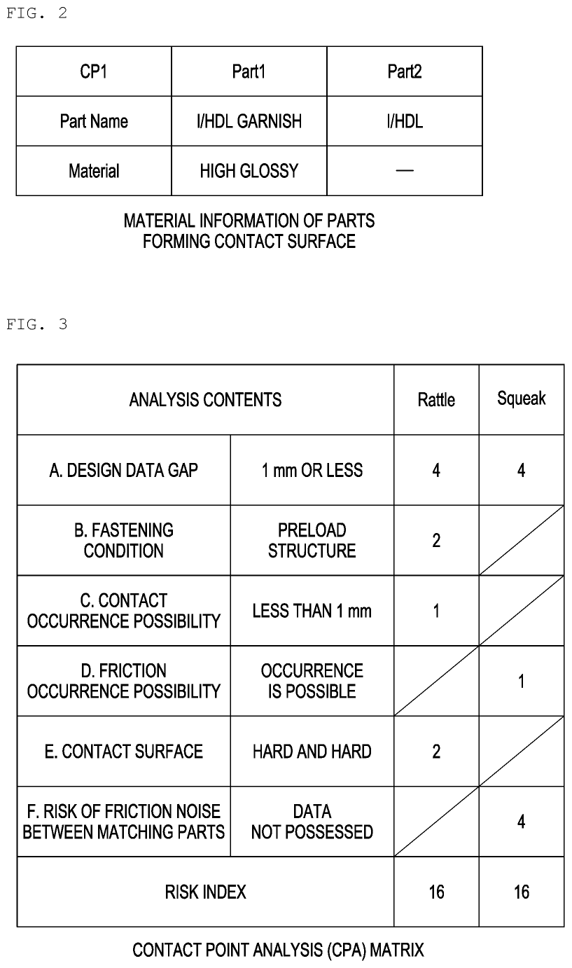

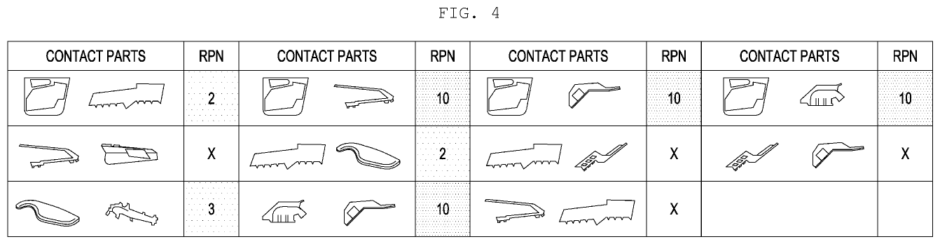

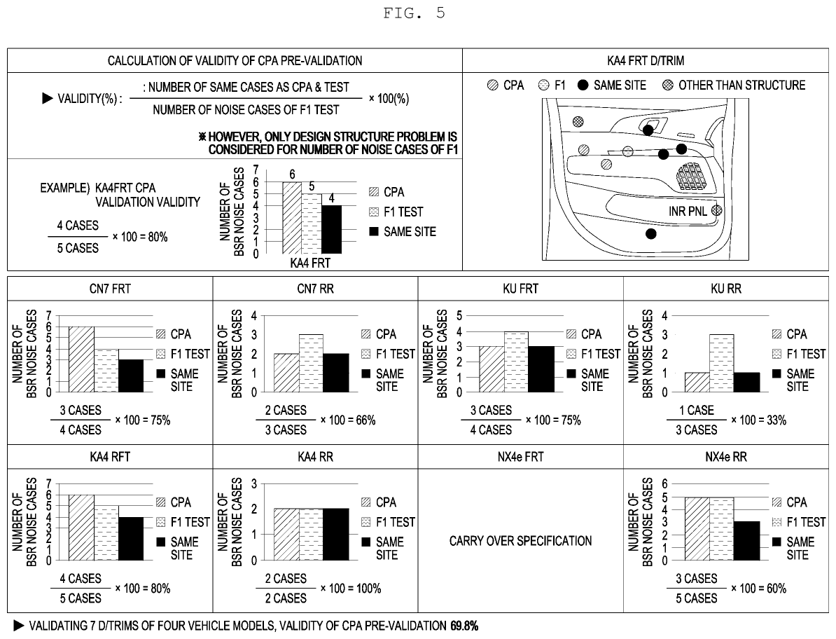

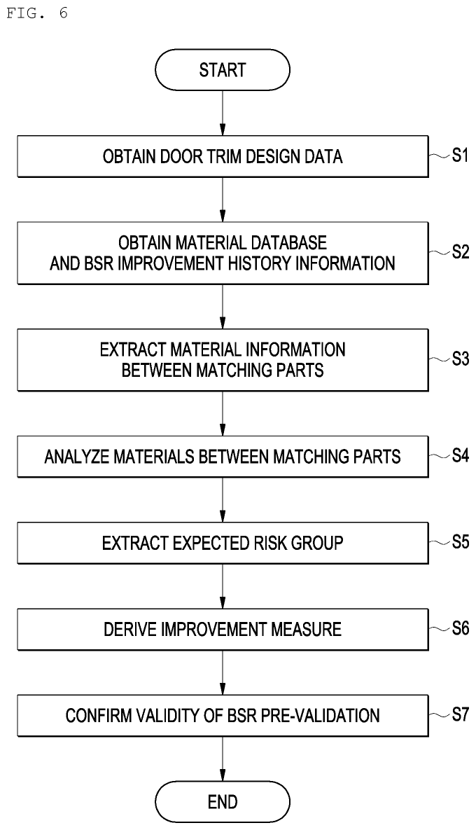

FIG. 2 is a diagram exemplarily illustrating that material information of parts forming a contact surface which is a BSR pre-validation target is extracted from a material database according to an exemplary embodiment, FIG. 3 is a diagram exemplarily illustrating a CPA matrix according to an exemplary embodiment, FIG. 4 is a diagram exemplarily illustrating a risk of friction noise between matching parts for each contact surface, and FIG. 5 is a diagram illustrating a CPA pre-validation validity confirmed in a CPA pre-validation validity calculation formula and an actual test process according to an exemplary embodiment.

Referring to FIGS. 2 to 5, specific contents regarding a case where the BSR pre-validation system 100 according to an exemplary embodiment performs the BSR pre-validation and confirms the validity are described.

Referring to FIG. 2, material information between matching parts may be confirmed. The material information between matching parts is extracted from the material database. Here, CP1 represents contact surface 1, Part1 and Part2represent matching parts forming contact surface 1, Part Name represents a part name, and Material represents a part material.

The CPA matrix includes parameter items and values corresponding thereto for calculating the rattle risk index and the squeak risk index, as illustrated in FIG. 3. Item A represents the design data gap, item B represents the fastening condition, item C represents the contact occurrence possibility, item D represents the friction occurrence possibility, item E represents the contact surface, and item F represents the risk of friction noise between matching parts. Here, the risk of friction noise between matching parts to be described below is determined in advance by the material analysis unit 120, and provided to the CPA matrix.

According to the exemplary embodiment of FIG. 3, the design data gap, which is item A in the CPA matrix for a specific contact surface, is 1 mm or less on door trim design data. Item A is a parameter item that is commonly applied to the rattle risk index and the squeak risk index, so each is given 4 points.

The fastening condition, which is item B is a parameter item that is applied only to the rattle risk index, has a preload structure, and is given 2 points.

The contact occurrence possibility, which is item C is a parameter item that is applied only to the rattle risk index, is less than 10 mm, and is given 1 point.

The friction occurrence possibility, which is item D is a parameter item that is applied only to the squeak risk index, is possible to occur, and is given 1 point.

The contact surface, which is item E is a parameter item that is applied only to the rattle risk index, is hard and hard (material properties of contact surfaces of matching parts), and is given 2 points.

Last, the risk of friction noise between matching parts, which is item F is a parameter item that is applied only to the squeak risk index, does not possess data, and is given 4 points. That is, the non-possession of data means that the item may not be determined by the pre-validation unit 130, and the score determined by the material analysis unit 120 is provided to the pre-validation unit 130 and given as the score of item F of the CPA matrix.

Here, each of the rattle risk index and the squeak risk index is calculated as follows.

The rattle risk index is 16 points by multiplying the scores for respective items A, B, C, and E, and the squeak risk index is 16 points by multiplying the scores for respective items A, D, and F.

The preset threshold may be the same threshold for both the rattle risk index and the squeak risk index, or the indexes have different thresholds. However, for the convenience of description, it is assumed here that the preset thresholds of the rattle risk index and the squeak risk index are the same.

For example, if the preset threshold is 15, the contact surface is determined to be the expected risk group because the rattle risk index and the squeak risk index are greater than or equal to the preset threshold.

As illustrated in FIG. 4, the material analysis unit 120 may determine the risk of the friction noise between the matching parts for each contact surface based on a squeak noise test result value between respective matching parts stored in the material database.

According to an exemplary embodiment, the risk of friction noise between matching parts may be classified into 10 levels by indexing a magnitude of a surface acceleration signal, the number of occurrences, and total energy. Since the material database stores the result value of testing the squeak noise between respective matching parts under various conditions such as temperature and humidity in advance using stick-slip test equipment, the material analysis unit 120 may determine the risk of friction noise between matching parts based thereon.

In FIG. 4, a number indicates which level the risk of friction noise between the corresponding matching parts is among 10 levels, and a higher number indicates a higher level of risk. X indicates that there is no risk.

As illustrated in FIG. 5, the validity confirmation unit 150 may confirm the validity based on whether the expected risk group and an actual BSR generation site shown as the single-item validation result are identical. Here, the validity determined based on the BSR pre-validation and actual single-time validation results for seven door trims of four vehicle models may be confirmed. The validity may be expressed as a probability, i.e., %.

Referring to FIG. 5, the validity of the BSR pre-validation may be a ratio of the number of noise cases (green) confirmed at the same site as the expected risk group to the number of noise cases (red) confirmed in an F1 test (single-item validation) result. Further, the number of noise cases which are not caused due to the design structure may be excluded from the number of noise cases confirmed in the single-item validation result. For example, in the door trim drawing of FIG. 5, skin peeling and INR PNL (inner panel) marked in orange are noise generating sites caused by causes other than defects in the design structure, and are not related to the BSR pre-validation, so the skin peeling and the INR PNL (inner panel) are not included in the number of noise cases confirmed in the F1 test (single-item validation) result.

A validity for an FRT (front) door trim of a CN7 vehicle type may be calculated as follows. The number of noise cases (blue) of the expected risk group determined in the CPA (or BSR pre-validation) is 6, the number of noise cases (red) confirmed in the F1 test (single-item validation) result is 4, and the number of noise cases (green) confirmed at the same site among them is 3. Therefore, a ratio of 3 noise cases (green) confirmed at the same site as the expected risk group determined in the CPA (BSR pre-validation) to 4 noise cases (red) confirmed in the F1 test (single-item) validation result is calculated as 75%.

As such, the validity confirmation unit 150 determines how accurately the prediction for the same site is made among the number of noise cases confirmed in the actual F1 test (single-item validation) result as the expected risk group determined during the BSR pre-validation. The validity may be used as feedback data for increasing prediction accuracy by adjusting the parameter items or score systems, the preset thresholds of the rattle risk index and the squeak risk index, etc., for future BSR pre-validation, which are stored in the system.

FIG. 6 is a flowchart illustrating a BSR pre-validation method according to an exemplary embodiment.

As illustrated in FIG. 6, the BSR pre-validation method may include a step (S1) of obtaining door trim design data, a step (S2) of obtaining a material database, and BSR improvement history information, a material information extracting step (S3) of extracting material information of parts forming a contact surface based on the door trim design data and the material database, a material analyzing step (S4) of determining the risk of friction noise between matching parts for each contact surface based on the material database, a BSR pre-validating step (S5) of determining contact surfaces having a squeak risk index or rattle risk index higher than or equal to a preset threshold value based on the material information, the risk of friction noise between matching parts, and a CPA matrix for each contact surface as an expected risk group, an improvement measure deriving step (S6) of deriving improvement measures for the expected risk group based on the BSR improvement history information, and a validity confirming step (S7) of confirming the validity of the BSR pre-validation based on a single-item validation result for a door trim prototype produced based on the door trim design data, and the expected risk group.

In the material analyzing step (S4), the risk of friction noise between matching parts may be determined by considering at least one of temperature, humidity, material, load, and speed.

In the BSR pre-validating step (S5), the squeak risk index may be determined based on the design data gap between matching parts, the friction occurrence possibility, and the risk of friction noise between matching parts for each contact surface.

In the BSR pre-validating step (S5), the rattle risk index may be determined based on the design data gap between matching parts, the fastening condition, the contact occurrence possibility, and the contact surface for each contact surface.

The validity of the BSR pre-validation may be a ratio of the number of noise cases confirmed at the same site as the expected risk group to the number of noise cases confirmed in the single-item validation result.

The number of noise cases which are not caused due to the design structure may be excluded from the number of noise cases confirmed in the single-item validation result.

The above description just illustrates the technical spirit of the present disclosure and various changes and modifications can be made by those skilled in the art to which the present disclosure pertains without departing from an essential characteristic of the present disclosure. Therefore, the exemplary embodiments of the present disclosure are provided for illustrative purposes only but not intended to limit the technical concept of the present disclosure. The scope of the technical concept of the present disclosure is not limited thereto. The protective scope of the present disclosure should be construed based on the following claims, and all technical ideas in the equivalent scope thereof should be construed as falling within the scope of the present disclosure.

What is claimed is:

1. A BSR pre-validation system with door trim contact point analysis, comprising:
an information collection unit obtaining door trim design data, a material database, and buzz, squeak, and rattle (BSR) improvement history information;
a material analysis unit extracting material information of parts forming a contact surface based on the door trim design data and the material database, and determining a risk of friction noise between matching parts for each contact surface based on the material database;
a pre-validation unit determining a contact surface having a squeak risk index or rattle risk index higher than or equal to a preset threshold value as an expected risk group based on the material information, the risk of friction noise between matching parts, and a contact point analysis (CPA) matrix for the each contact surface; and
an improvement measure derivation unit deriving an improvement measure for the expected risk group based on the BSR improvement history information.

2. The BSR pre-validation system according to claim 1, wherein the material analysis unit determines the risk of friction noise between matching parts by considering at least one or more of temperature, humidity, material, load, and speed.

3. The BSR pre-validation system according to claim 1, wherein the pre-validation unit determines the squeak risk index based on a design data gap between matching parts, a friction occurrence possibility, and the risk of friction noise between matching parts for the each contact surface.

4. The BSR pre-validation system according to claim 1, wherein the pre-validation unit determines the rattle risk index based on the design data gap between matching parts, a fastening condition, a contact occurrence possibility, and a contact surface for the each contact surface.

5. The BSR pre-validation system according to claim 1, further comprising:
a validity confirmation unit confirming a validity of the BSR pre-validation based on a single-item validation result for a door trim prototype produced based on the door trim design data, and the expected risk group.

6. The BSR pre-validation system according to claim 5, wherein the validity of the BSR pre-validation is a ratio of the number of noise cases confirmed at the same site as the expected risk group to the number of noise cases confirmed in the single-item validation result.

7. The BSR pre-validation system according to claim 6, wherein the number of noise cases which are not caused due to a design structure is excluded from the number of noise cases confirmed in the single-item validation result.

8. A BSR pre-validation method with door trim contact point analysis, comprising:
a step of obtaining door trim design data;
a step of obtaining a material database, and buzz, squeak, and rattle (BSR) improvement history information;
a material 1 information extracting step of extracting material information of parts forming a contact surface based on the door trim design data and the material database;
a material analyzing step of determining a risk of friction noise between matching parts for each contact surface based on the material database;
a BSR pre-validating step of determining contact surfaces having a squeak risk index or rattle risk index higher than or equal to a preset threshold value based on the material information, the risk of friction noise between matching parts, and a contact point analysis (CPA) matrix for the each contact surface as an expected risk group; and
an improvement measure deriving step of deriving an improvement measure for the expected risk group based on the BSR improvement history information.

9. The BSR pre-validation method according to claim 8, wherein in the material analyzing step, the risk of friction noise between matching parts is determined by considering at least one of temperature, humidity, material, load, and speed.

10. The BSR pre-validation method according to claim 8, wherein in the BSR pre-validating step, the squeak risk index is determined based on a design data gap between matching parts, a friction occurrence possibility, and the risk of friction noise between matching parts for the each contact surface.

11. The BSR pre-validation method according to claim 8, wherein in the BSR pre-validating step, the rattle risk index is determined based on the design data gap between matching parts, a fastening condition, a contact occurrence possibility, and a contact surface for the each contact surface.

12. The BSR pre-validation method according to claim 8, further comprising:
a validity confirming step of confirming a validity of the BSR pre-validation based on a single-item validation result for a door trim prototype produced based on the door trim design data, and the expected risk group.

13. The BSR pre-validation method according to claim 12, wherein the validity of the BSR pre-validation is a ratio of the number of noise cases confirmed at the same site as the expected risk group to the number of noise cases confirmed in the single-item validation result.

14. The BSR pre-validation method according to claim 12, wherein the number of noise cases which are not caused due to a design structure is excluded from the number of noise cases confirmed in the single-item validation result.
